(19) United States
(12) Patent Application Publication
(10) Pub. No.: US 2026/0142407 A1
(43) Pub. Date: May 21, 2026

(54) ELECTRICAL CONNECTOR ASSEMBLY AND SYSTEM

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: HAOZHE ZI, Irvine, CA (US); Terrance F. Little, Fullerton, CA (US); An-Jen Yang, Irvine, CA (US)

(21) Appl. No.: 18/953,488

(22) Filed: Nov. 20, 2024

(51) Int. Cl. H01R 13/514; H01R 12/75; H01R 13/24; H01R 13/6587

(52) U.S. Cl. CPC H01R 13/514; H01R 12/75; H01R 13/2435; H01R 13/6587

(57) ABSTRACT

An electrical connector assembly includes: a first connector and a second connector; a circuit board; and an electrical connector mounted on the circuit board, the first connector and the second connector connected with the electrical connector from both sides of the circuit board respectively, the electrical connector including: an insulating housing; plural pairs of terminals held in the insulating housing, each terminal pair including a first terminal and a second terminal; each first terminal includes a first elastic arm and a second elastic arm respectively exposed from both sides of the insulating housing, each second terminal includes a third elastic arm and a fourth elastic arm respectively exposed from both sides of the insulating housing, the first elastic arm and the third elastic arm are arranged in mirror symmetry with the second elastic arm and the fourth elastic arm with respect to the circuit board.

### BACKGROUND OF THE INVENTION

### Field of the Invention

The present invention generally relates to an electrical connector, an electrical connector assembly and an electrical connector system to transmit high-speed differential signals.

### Description of Related Arts

U.S. Pat. No. 11,616,313 discloses a structure of connecting cable conductors to signal pads that are provided in a signal layer of a board where the conductors are each attached to a support via by laser welding and the support via is connected by a short trace to the signal pad. To connect a shield layer of the cable to ground pads or ground plane on the board, a pedestal may be provided. U.S. Pat. No. 10,594,085 discloses a communication system including a circuit board assembly, a first connector assembly configured to be connected to one side of the circuit board assembly, and a second connector assembly configured to be connected to an opposite side of the circuit board assembly. The circuit board assembly is used to electrically connect the first connector component and the second connector component. The circuit board assembly includes a circuit board and a first header connector mounted on one side of the circuit board and connected to the first connector assembly, and a second header connector mounted on the other side of the circuit board and connected to the second connector assembly. The first header connector and the second header connector each include a housing and a plurality of electrical contacts. The circuit board is provided with a plurality of conductive vias, and the contacts of the first header connector and the second header connector are received in the same conductive vias to define a signal path directly through the circuit board. The first header connector and the second header connector are connected through the conductive vias of the circuit board, which is not conducive to the stability of signal transmission, and the structure is also relatively complex. Therefore, an improved electrical connector design is desired.

### SUMMARY OF THE INVENTION

The main object of the present invention is to provide an improved electrical connector with stable signal transmission, effective crosstalk control, and a relatively simple structure.

To achieve the above-mentioned object, an electrical connector adapted for being mounted on a frame and connected with two mating connectors on both sides of the frame comprises: an insulating housing having a plurality of through holes; a plurality of pairs of terminals held in the through holes and each pair comprising a first terminal and a second terminal for transmitting differential signals; and a ground shield member held in the insulating housing and arranged around each pair of terminals, wherein each first terminal comprises a first elastic arm and a second elastic arm respectively exposed from both sides of the through hole, each second terminal comprises a third elastic arm and a fourth elastic arm respectively exposed from both sides of the through hole, and the first elastic arm and the third elastic arm are arranged in mirror symmetry with the second elastic arm and the fourth elastic arm with respect to the frame.

To achieve the above-mentioned object, an electrical connector assembly comprises: a first connector and a second connector; a circuit board comprising a first side, a second side opposite to the first side; and an electrical connector mounted on the circuit board, the first connector and the second connector connected with the electrical connector from both sides of the circuit board respectively, the electrical connector comprising: an insulating housing having a plurality of through holes; a plurality of pairs of terminals arranged in rows and columns held in the through holes, each terminal pair comprising a first terminal and a second terminal for transmitting differential signals; and a ground shield member held in the insulating housing and arranged around each pair of terminals, wherein each first terminal comprises a first elastic arm and a second elastic arm respectively exposed from both sides of the through hole, each second terminal comprises a third elastic arm and a fourth elastic arm respectively exposed from both sides of the through hole, and the first elastic arm and the third elastic arm are arranged in mirror symmetry with the second elastic arm and the fourth elastic arm with respect to the circuit board.

To achieve the above-mentioned object, an electrical connector system comprises: an organizer comprising a first side a second side opposite to the first side; and a plurality of electrical connector assemblies each comprising an electrical connector held on the organizer and a first connector and a second connector connected with the electrical connector from both sides of the organizer respectively, the electrical connector comprising: an insulating housing having a plurality of through holes; a plurality of terminals pairs arranged in rows and columns held in the through holes, each terminal pair comprising a first terminal and a second terminal for transmitting differential signals; and a ground shield member held in the insulating housing and arranged around each pair of terminals;

wherein each first terminal comprises a first elastic arm and a second elastic arm respectively exposed from both sides of the through hole, each second terminal comprises a third elastic arm and a fourth elastic arm respectively exposed from both sides of the through hole, and the first elastic arm and the third elastic arm are arranged in mirror symmetry with the second elastic arm and the fourth elastic arm with respect to the organizer.

Compared to prior art, the electrical connector in the present invention is connected with the two mating connectors on both sides through symmetrical elastic arms, it has stable signal transmission, effective crosstalk control, and a relatively simple structure.

### BRIEF DESCRIPTION OF DRAWINGS

FIG. 1 is a perspective view of an electrical connector assembly, wherein the circuit board is not shown;

FIG. 2 is an exploded view of the electrical connector assembly shown in FIG. 1;

FIG. 3 is a perspective view and a partial enlarged view of the electrical connector shown in FIG. 1;

FIG. 4 is an another perspective view of the electrical connector shown in FIG. 3;

FIG. 5 is a perspective view and a partial enlarged view of the electrical connector shown in FIG. 3, wherein the insulating housing is removed;

FIG. 6 is an another perspective view and a partial enlarged view of the electrical connector shown in FIG. 4, wherein the insulating housing is removed;

FIG. 7 is a perspective view of a pair of terminals of the electrical connector shown in FIG. 4;

FIG. 8 is a perspective view of the first connector shown in FIG. 2;

FIG. 9 is a further exploded view of the first connector shown in FIG. 8;

FIG. 10 is a perspective view of two terminal modules of the first connector shown in FIG. 9;

FIG. 11 is an another perspective view of two terminal modules of the first connector shown in FIG. 10;

FIG. 12 is a perspective view of a terminal module shown in FIG. 10;

FIG. 13 is a further exploded view of the terminal module shown in FIG. 12;

FIG. 14 is an another exploded view and a partial enlarged view of the terminal module shown in FIG. 13;

FIG. 15 is an exploded view of the terminal module shown in FIG. 14;

FIG. 16 is a perspective view and a partial enlarged view of the electrical connector assembly shown in FIG. 16, wherein the insulating housing of the electrical connector and the first connector and the second connector are removed;

FIG. 17 is a partial cross-sectional view of the electrical connector assembly shown in FIG. 1 along line A-A;

FIG. 18 is a perspective view of a terminal module of the first connector and a terminal module of the second connector connected through the terminals of the electrical connector;

FIG. 19 is a front view of a terminal module of the first connector and a terminal module of the second connector connected through the terminals of the electrical connector shown in FIG. 18; and

FIG. 20 is a schematic diagram of the electrical connector system.

### DETAILED DESCRIPTION OF DRAWINGS

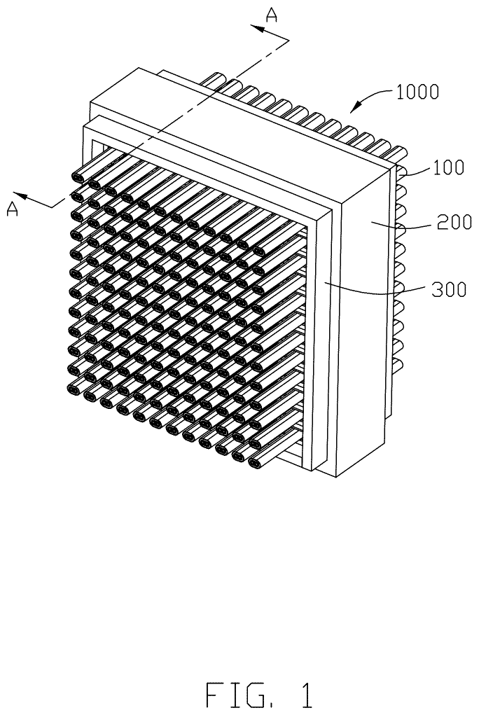

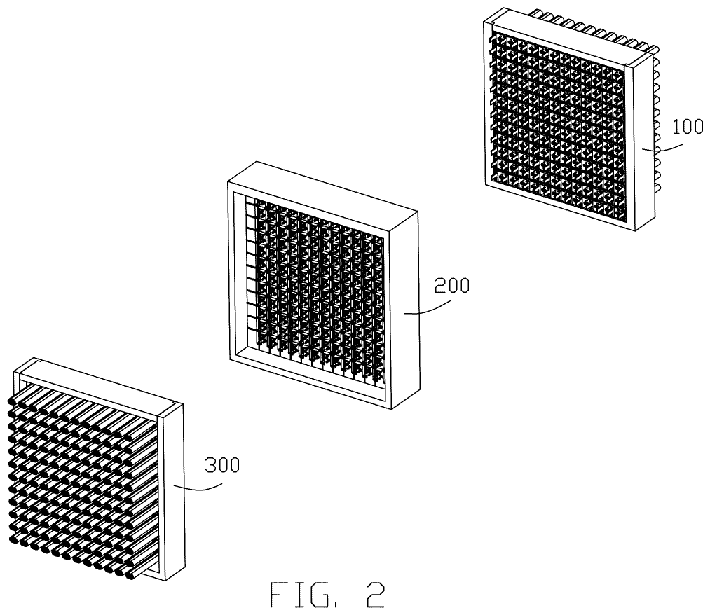

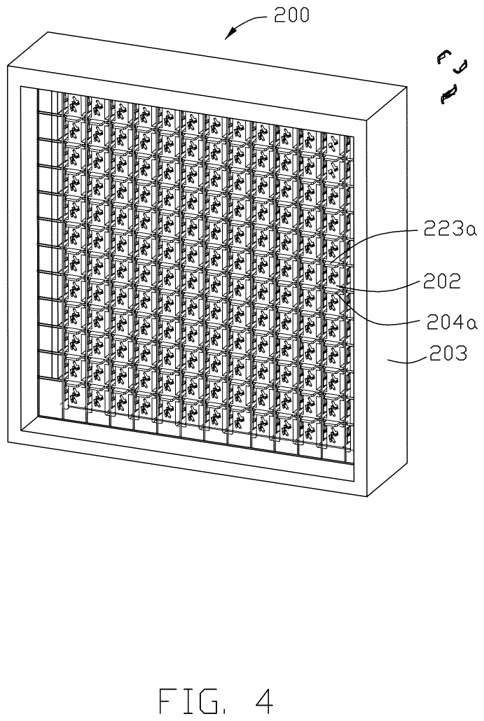

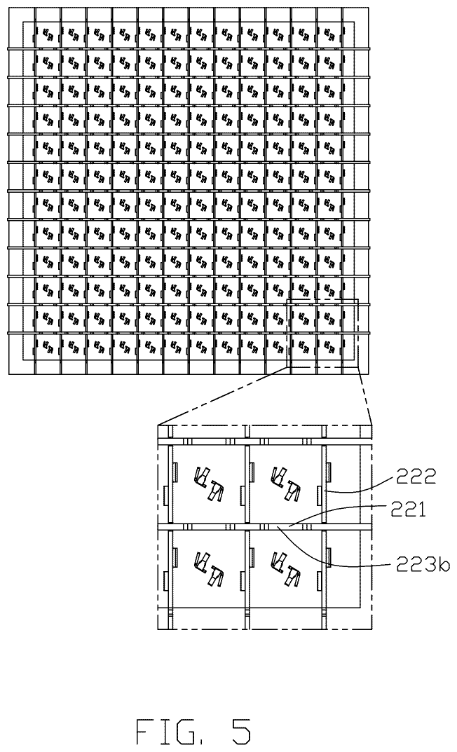

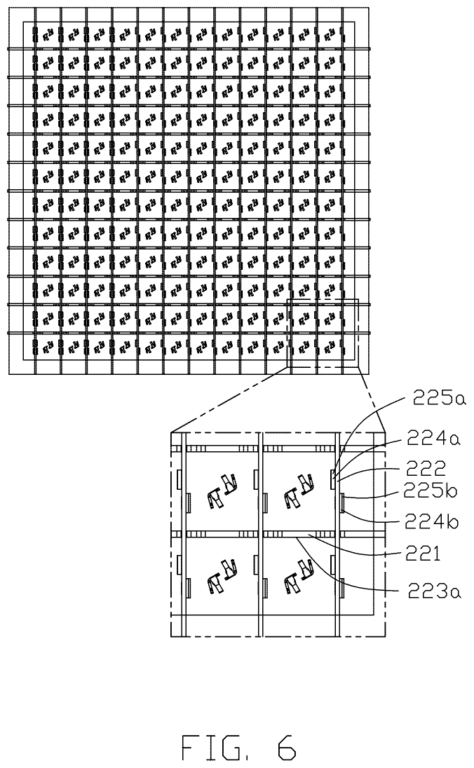

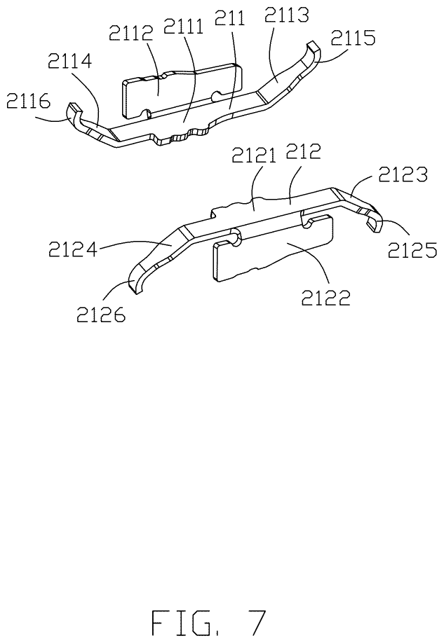

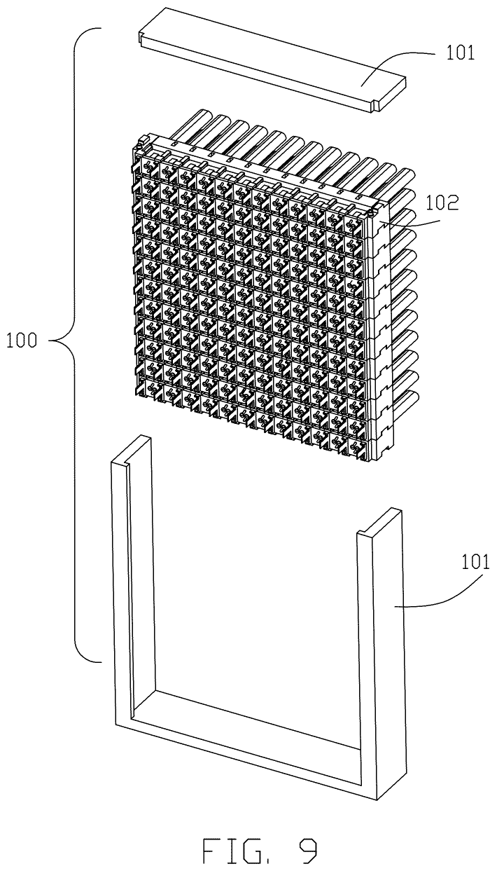

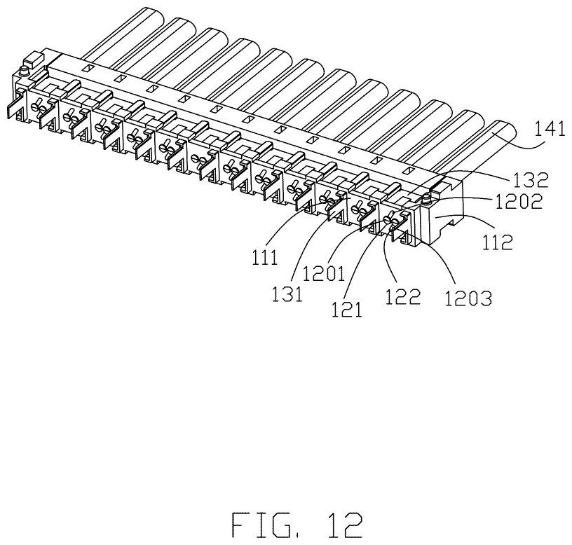

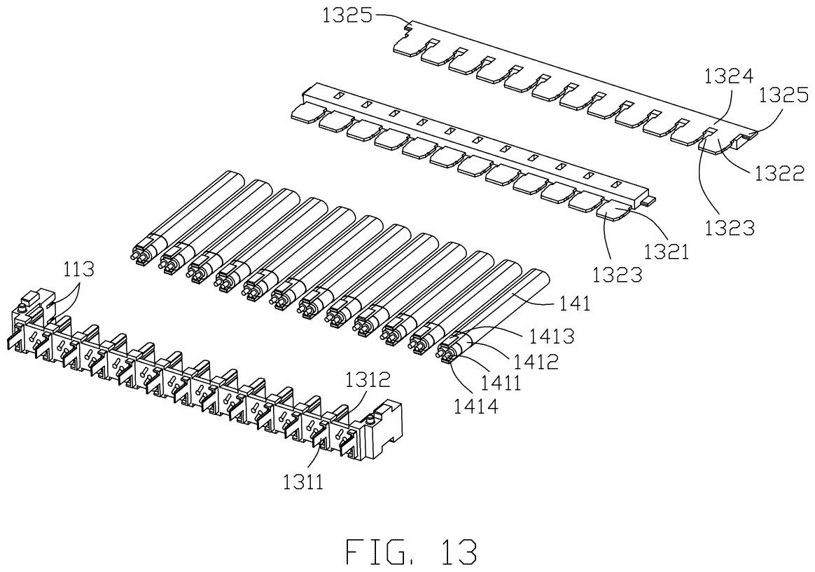

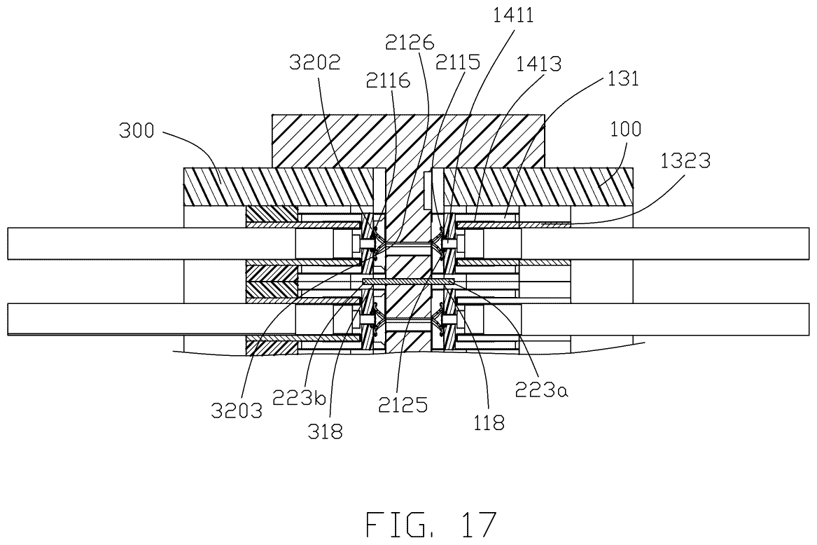

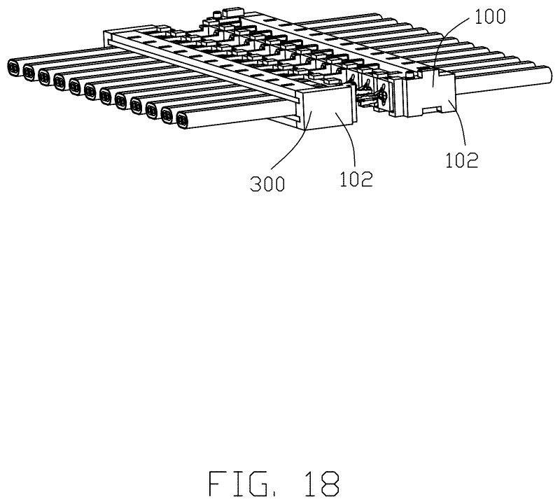

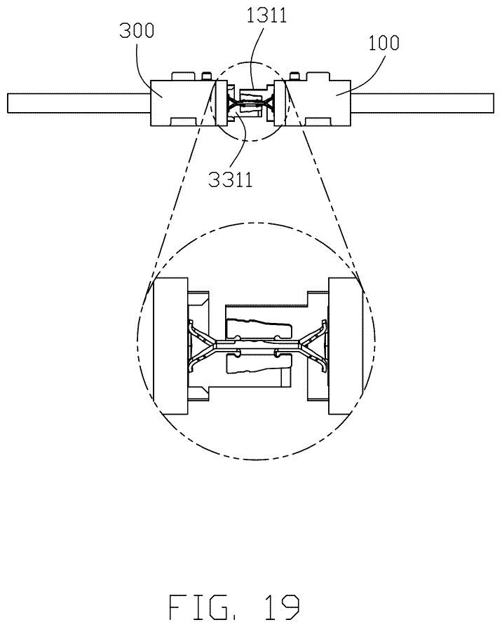

Referring to FIGS. 1-20, it shows the electrical connector assembly 1000 of the present invention. The electrical connector assembly 1000 includes a circuit board (not shown), an electrical connector 200 mounted on the circuit board, and a first connector 100 and a second connector 300 connected with the electrical connector 200. The circuit board includes a first side, a second side opposite to the first side. The first connector 100 and the second connector 300 are connected with the electrical connector 200 from the first side and the second side respectively. The first connector 100 and the second connector 300 are both cable end connectors.

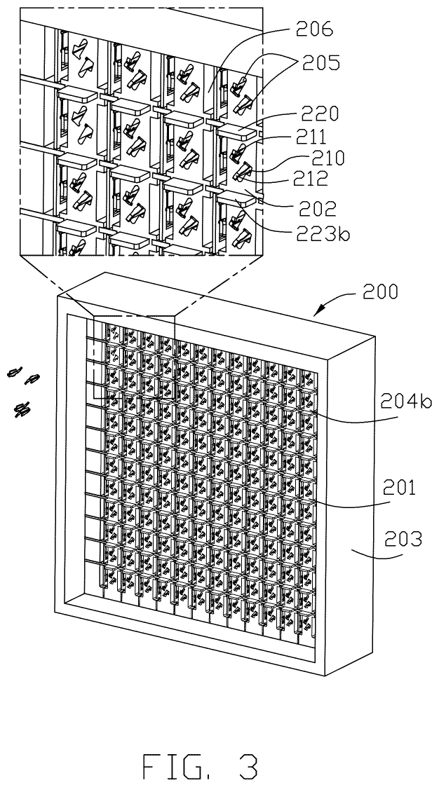

Referring to FIGS. 3-7, the electrical connector 200 includes an insulating housing 201, a plurality of terminals 210 held in the insulating housing 201, and a ground shield member 220 held in the insulating housing 201. The plurality of terminals 210 are arranged in pairs each including a first terminal 211 and a second terminal 212 for transmitting differential signals. The insulating housing 201 includes a middle wall 202 and four side walls 203 arranged around the intermediate wall 202. The middle wall 202 and the four side walls 203 together form a first receiving space 204a that can receive the first connector 100 and a second receiving space 204b that can receive the second connector 300. The middle wall 202 is provided with paired through holes 205 for holding the terminals. The first terminal 211 and the second terminal 212 have the same structure and are arranged oppositely. The first terminal 211 includes a first main body part 2111 held in the through hole 205, a second main body part 2112 bent and extended from the side edge of the first main body part 2111 and held in the through hole 205, a first elastic arm 2113 extended upward and obliquely at an angle with one side of the first main body 2111, and a second elastic arm 2114 extended upward and obliquely at the same angle with the other side of the first body portion 2111. The first elastic arm 2113 is exposed in the first receiving space 204a and the second elastic arm 2114 is exposed in the second receiving space 204b. The second terminal 212 includes a first main body part 2121 held in the through hole 205, a second main body part 2122 bent and extended from the side edge of the first main body part 2121 and held in the through hole 205, a third elastic arm 2123 extended downward and obliquely at an angle with one side of the first main body 2121, and a fourth elastic arm 2124 extended downward and obliquely at the same angle with the other side of the first body portion 2121. The third elastic arm 2123 is exposed in the first receiving space 204a and the fourth elastic arm 2124 is exposed in the second receiving space 204b. The first elastic arm 2113 and the third elastic arm 2123 are arranged in mirror symmetry with the second elastic arm 2114 and the fourth elastic arm 2124 with respect to the middle wall 202.

The free ends of the first elastic arm 2113 and the third elastic arm 2123 are provided with a first mating portion 2115 and a second mating portion 2125 respectively connected with the first connector 100. The first mating portion 2115 and the second mating portion 2125 are both in a plane parallel to the middle wall 202. The free ends of the second elastic arm 2114 and the fourth elastic arm 2124 are provided with a third mating portion 2116 and a fourth mating portion 2126 respectively connected with the second connector 300. The third mating portion 2116 and the fourth mating portion 2126 are both in a plane parallel to the middle wall 202.

The through holes 205 are arranged in the middle wall 202 in a plurality of rows and columns, and a plurality of pairs of terminals 210 are arranged in a plurality of rows and columns in the corresponding through holes 205. In this embodiment, the terminals 210 are arranged in a square shape and arranged in 12 rows and 12 columns. In other embodiments, it can also be arranged in a 3*3, or 6*6, or 8*8 arrangement, which is not limited by this application. The ground shield 220 includes a plurality of first ground shield pieces 221 and second ground shield pieces 222 arranged in rows and columns. The plurality of first ground shield pieces 221 and the second ground shield pieces 222 form a plurality of shielding cavities respectively surrounding each pair of the terminals 210. In this embodiment, the ground shield member 220 includes 11 first ground shield pieces 221 arranged laterally and 13 second ground shield pieces 222 arranged longitudinally. Except for the terminals 210 in the first and last rows being surrounded by the first ground shield pieces 221 and the second ground shield pieces 222 in three directions, the remaining terminals 210 are surrounded by the first ground shield pieces 221 and the second ground shield pieces 222 in four directions. The first ground shield piece 221 includes a plurality of first mating tabs 223a protruding to the first receiving space 204a and a plurality of second mating tabs 223b protruding to the second receiving space 204b. The middle wall 202 is provided with a plurality of channels 206 located on both sides of each pair of terminals. The second ground shield piece 222 is provided with a first contact elastic piece 224a and a second contact elastic piece 224b exposed in the channel. The first contact elastic piece 224a and the second contact elastic piece 224b are arranged up and down along the longitudinal direction of the second ground shielding piece 222. The first contact elastic piece 224a is provided with a first contact protrusion 225a protruding toward the terminal on one side, and the second contact elastic piece 224b is provided with a second contact protrusion 225b protruding toward the terminal on the other side.

The first connector 100 and the second connector 300 substantially have the same structure. The following description takes the first connector 100 as an example for detailed description.

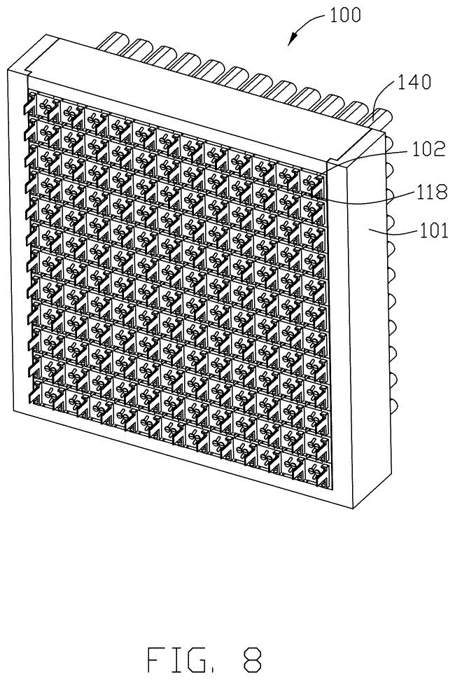

Referring to FIGS. 8-15, the first connector 100 includes an insulating housing 101 and a plurality of terminal modules 102 stacked up and down and held in the insulating housing 101. The terminal module 102 includes an insulating body 110, a plurality of signal terminals 120 and a grounding member 130 integrally formed with the insulating body 110, and a cable 140 extending in the first direction connected correspondingly to the signal terminal 120 and the grounding member 130. A plurality of the signal terminals 120 are arranged in pairs and in a row along a second direction perpendicular to the first direction, including first signal terminals 121 and second signal terminals 122 for transmitting differential signals. In this embodiment, the first connector 100 has 12 terminal modules stacked up and down, and each terminal module 102 includes 12 pairs of signal terminals. In other embodiments, the number of terminal modules 102 and the number of signal terminals 120 can be designed according to specific requirements. The grounding member 130 includes a plurality of grounding pieces 131 provided on both sides of each pair of signal terminals 120 and a common grounding piece 132 connected to a plurality of the grounding pieces 131. The cable 140 includes a plurality of drainless twinax cables 141 arranged in a row. The twinax cable 141 includes two signal conductors 1411 correspondingly connected to each pair of the signal terminals 120 and a conductive layer 1412 disposed outside the two signal conductors 1411 and electrically connected to the grounding pieces 131.

The insulating body 110 includes a main body portion 111 holding the signal terminal 120 and the grounding piece 131 and two side portions 112 provided on both sides of the main body portion 111. The signal terminal 120 includes a first contact portion 1201 connected with the signal conductor 1411 and a second contact portion 1202 arranged at an angle with the first contact portion 1201 and connected with the terminal 210 of the electrical connector 200. The first contact portion 1201 and the second contact portion 1202 are embedded in the main body portion 111 and are in the same plane perpendicular to the first direction. The first contact portion 1201 has a circular through-hole structure. After the signal conductor 1411 passes through the through-hole, the signal conductor 1411 is mechanically and electrically connected with the first contact portion 1201 through laser welding. The second contact portion 1202 is in a strip shape. The second contact portions 1202,1203 of the pair of signal terminals 120 are parallel to each other and extend obliquely in opposite directions from corresponding first contact portions 1201. In this way, the design of the signal terminal increases space utilization as much as possible. The signal conductor 1411 is connected with the first contact portion 1201 of the signal terminal 120 where, if necessary, the pitch between two signal conductors may be reduced according to design requirements.

Each grounding piece 131 includes a first ground portion 1311 and a second ground portion 1312. The first ground portion 1311 extends from one side of the insulating body 110 to the mating direction and beyond the signal terminals 120, and the second ground portion 1312 extends from the other side of the insulating body to the cable direction and is connected with the common grounding piece 132. The common grounding piece 132 includes a first common grounding piece 1321 and a second common grounding piece 1322 respectively provided on the upper and lower sides of the twinax cable 141. The first common grounding piece 1321 and the second common grounding piece 1322 are respectively held by an insulating block and have the same structure. Each of them includes a plurality of sub-common ground pieces 1323 arranged at intervals and a base portion 1324 connecting each of the sub-common ground pieces. Each of the sub-common ground pieces 1323 is disposed between two adjacent second ground portions 1312. The base portion 1324 is provided with protrusions 1325 on both sides, and both side portions 112 of the insulating body 110 are provided with grooves 113 that can receive the protrusions 1325. The first common grounding piece 1321 and the second common grounding piece 1322 are fixed to the insulating body 110 through the match of the protrusions 1325 and the grooves 113. Two upper and lower chutes 1313 are provided on the inner and outer sides of each second ground portion 1312. Both sides of each sub-common grounding piece 1323 enter the chutes of the two adjacent second ground portions 1312 for connection.

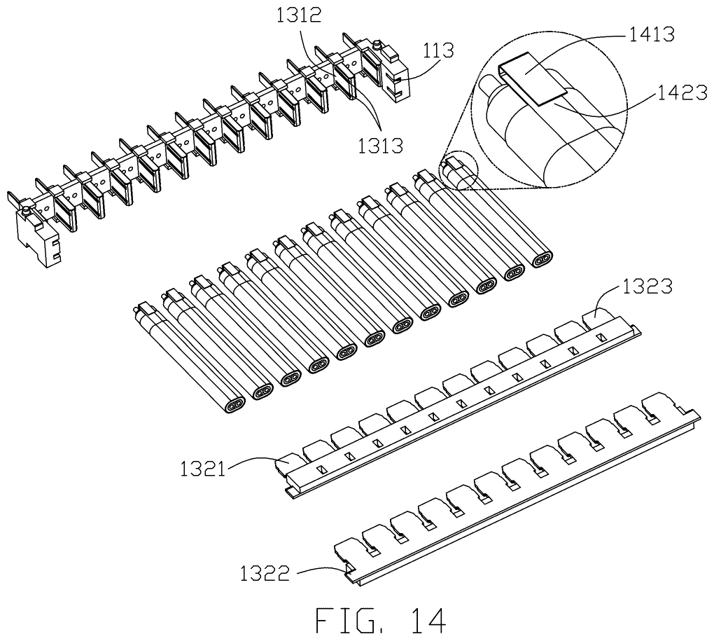

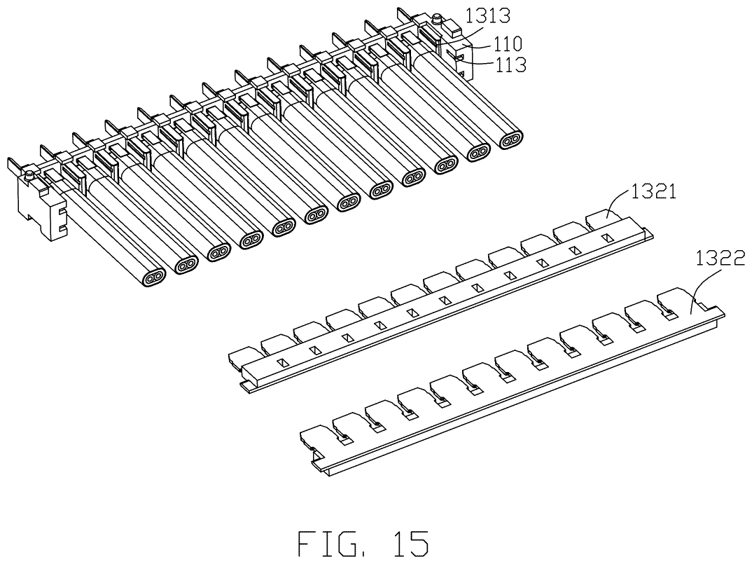

Referring to FIGS. 14-15, each twinax cable 141 includes a first conductive sheet 1413 and a second conductive sheet 1414 connected with the conductive layer 1412. The first conductive sheet 1413 extends from the middle position of the upper side of the conductive layer 142 toward the main body portion 111 and is folded upward and then continues to extend toward the cable direction. In this way, a U-shaped structure with a first opening 1423 is formed, and the sub-common grounding piece 1323 of the first common grounding piece 1321 enters the first opening 1423 to connect with the first conductive piece 1413. The second conductive sheet 1414 extends from the middle position of the lower side of the conductive layer 142 toward the main body portion 111 and is folded downward and then continues to extend toward the cable direction. In this way, a U-shaped structure with the second opening is formed, and the sub-common grounding piece 1323 of the second common grounding piece 1322 enters the second opening to connect with the second conductive piece 1414. The first conductive sheet 1413 and the second conductive sheet 1414 and the conductive layer 142 can be manufactured integrally, or they can be manufactured separately and then connected together. The first conductive sheet 1413, the second conductive sheet 1414, and the conductive layer 142 may be manufactured in one piece, or may be manufactured separately and then connected together, and they are all made of copper foil or aluminum foil. The connection between the sub-common grounding piece 1323 and the first conductive piece 1413 and the second conductive piece 1414 can be through contact connection or through laser soldering. The second ground portion 1312 of the grounding piece 131, the first common grounding piece 1321, and the second common grounding piece 1322 form a plurality of rectangular shielding surrounding spaces respectively surrounding each pair of the signal conductors 1411, thereby reducing crosstalk at this position.

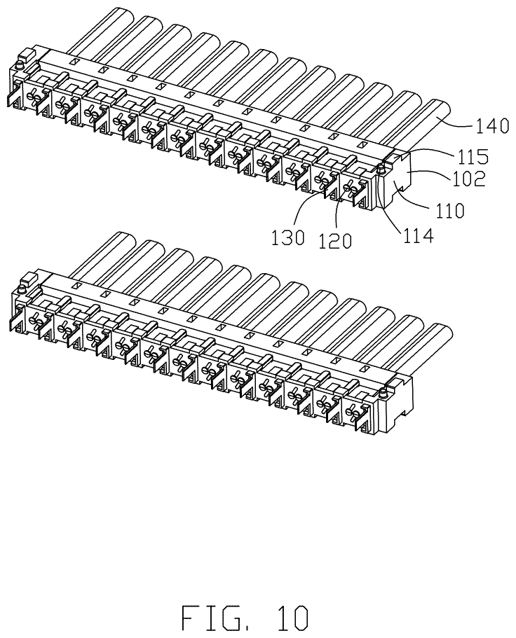

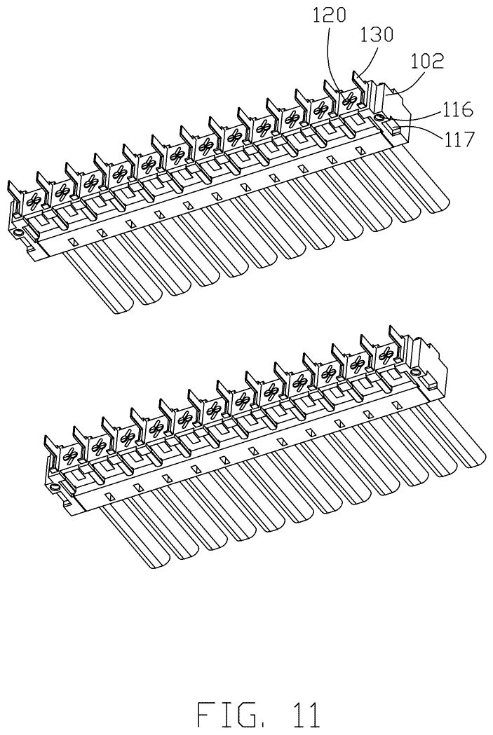

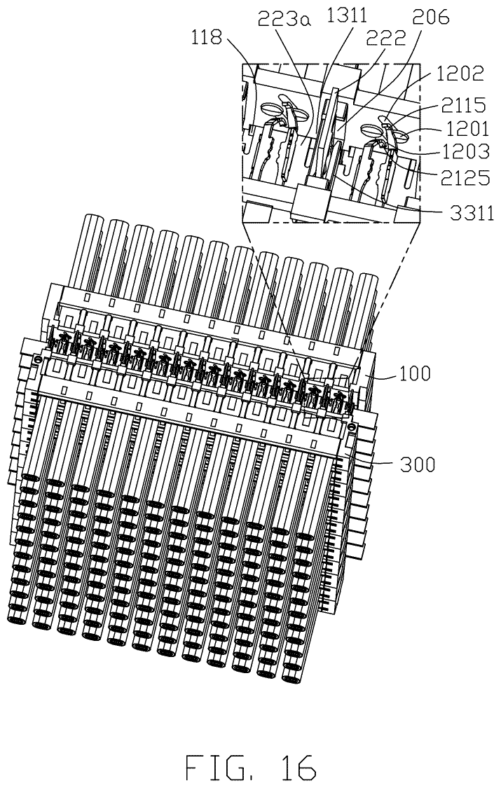

Referring to FIGS. 10-11, the side portion 112 of the insulating body 110 of each terminal module 102 is provided with a structure that can be fixed to the insulating body of the adjacent terminal module. Specifically, the upper side of each side portion 112 is provided with a positioning post 114 and a limiting block 115, and the lower side is provided with a positioning hole 116 and a limiting groove 117. When multiple terminal modules 102 are stacked up and down, the upper positioning posts 114 and limiting blocks 115 are respectively fixedly installed in the positioning holes 116 and limiting grooves 117 of the adjacent upper terminal modules, the lower positioning holes 116 and limiting grooves 117 receive the positioning posts 114 and limiting blocks 115 of the adjacent lower terminal modules. In this way, the terminal modules 102 are tightly assembled row by row and kept in the correct position. The main body portion 111 is provided with inward notch structures on both upper and lower sides corresponding to the position of the signal terminal 120. When a plurality of the terminal modules 102 are stacked one on another, the notches of the two terminal modules 102 on adjacent sides form a rectangular slot 118, as shown in FIG. 8 and FIG. 16.

Referring to FIGS. 16-19, for the first connector 100 and the second connector 300, except that the positions of first ground portion 1311 of the first connector 100 and the first ground portion 3311 of the second connection 300 are offset, other structures are the same. Thus, the structure of the second connector 300 will not be described in detail again. When the electrical connector 200 is connected with the first connector 100 and the second connector 300, the first mating portion 2115 and the second mating portion 2125 on one side of the electrical connector 200 are abutted and connected with the corresponding second contact portion 1202,1203 of the first connector 100, and the third mating portion 2116 and the fourth mating portion 2126 on the other side of the electrical connector 200 are abutted and connected with the corresponding second contact portion 3202 of the second connector 300. The first ground portion 1311 of the first connector 100 and the first ground portion 3311 of the second connector 300 both extend from opposite directions into the same channel 206 of the middle wall 202 of the electrical connector 200, and are respectively connected with the first contact protrusion 225a of the first contact elastic piece 224a and the second contact protrusion 225a of the second contact elastic piece 224b. A vertical shielding wall is established between each pair of high-speed differential signals in the vertical direction. The first mating tab 223a of the first ground shield piece 221 of the electrical connector 200 extends into the rectangular slot 118 between the adjacent terminal modules 102 of the first connector 100, and the second mating tab 223b of the first ground shield piece 221 of the electrical connector 200 extends into the rectangular slot 318 between the adjacent terminal modules 302 of the second connector 300. A horizontal shielding wall is established between each pair of high-speed differential signals in the horizontal direction. Except that each pair of high-speed differential signals in the first and last rows is surrounded by vertical shielding walls and horizontal shielding walls in three directions, each remaining pair of high-speed differential signals is completely surrounded by a shielding box formed by vertical shielding walls and horizontal shielding walls in four directions. Therefore, this design effectively controls crosstalk and noise.

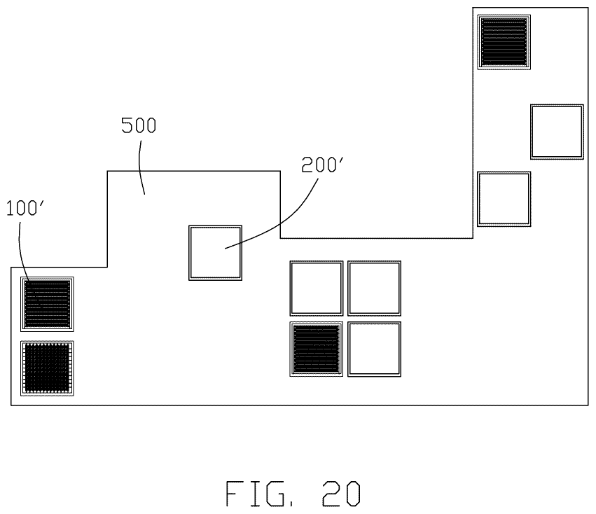

Referring to FIG. 20, in other embodiments, more than one electrical connector 200′ may be provided on the circuit board 500. These electrical connectors 200′ have the structure of the electrical connector as mentioned above, but different numbers of differential signal pairs and arrangements can be designed according to requirements. Multiple cable connectors 100′ are connected with the corresponding electrical connectors 200′ from both sides of the circuit board. Other electrical components can also be designed on the circuit board according to needs. In other embodiments, the circuit board may be replaced with a frame. Or, in other embodiment, instead of using a circuit board or frame to maintain the connection between the electrical connector and the cable connectors on both sides, the electrical connector can be directly designed as a large electrical connector that can connect multiple cable connectors on both sides at the same time. The insulating housing of this large electrical connector acts as an organizer directly, replacing the organizational function and integration function of the circuit board or frame. The electrical connector in the present invention is connected with the two cable connectors on both sides through symmetrical elastic arms, it has a relatively simple structure and stable signal transmission, and the space utilization is effectively improved. If the electrical connector is damaged during actual use, it can be easily replaced. The electrical connector, electrical connector assembly, and electrical connector system in the present invention can be used in a server, a switch, or a rack unit in any data center. Even more, it can not only be used within a rack unit, but can also be used to build electronic systems across different rack units and different layers, integrating the wires of the overall system. Therefore, it can be understood that the electrical connector, electrical connector assembly, and electrical connector system of the present invention can be flexibly used in many different applications.

1. An electrical connector adapted for being mounted on a frame and connected with two mating connectors on both sides of the frame, comprising:
an insulating housing having a plurality of through holes;
a plurality of pairs of terminals held in the through holes and each pair comprising a first terminal and a second terminal for transmitting differential signals; and
a ground shield member held in the insulating housing and arranged around each pair of terminals;
wherein each first terminal comprises a first elastic arm and a second elastic arm respectively exposed from both sides of the through hole, each second terminal comprises a third elastic arm and a fourth elastic arm respectively exposed from both sides of the through hole, and the first elastic arm and the third elastic arm are arranged in mirror symmetry with the second elastic arm and the fourth elastic arm with respect to the frame.

2. The electrical connector as claimed in claim 1, wherein the insulating body comprises a middle wall and four side walls arranged around the middle wall, the middle wall and the four side walls together form a first receiving space to receive a mating connector and a second receiving space to receive another mating connector.

3. The electrical connector as claimed in claim 2, wherein the through holes are provided on the middle wall, the first elastic arm and the third elastic arm are exposed in the first receiving space from one end of the through hole, and the second elastic arm and the fourth elastic arm are exposed in the second receiving space from the other end of the through hole.

4. The electrical connector as claimed in claim 1, wherein each of the first terminal and the second terminal comprises a first main body part held in the through hole, and a second main body part bent and extended from a side edge of the first main body portion and held in the through hole, the first elastic arm and the second elastic arm respectively extend obliquely in opposite directions from both sides of the first main body part, and both at the same angle as the first main body part, and the third elastic arm and the fourth elastic arm respectively extend obliquely in opposite directions from both sides of the first main body part, and both at the same angle as the first main body part.

5. The electrical connector as claimed in claim 4, wherein the first elastic arm and the third elastic arm are exposed from one end of corresponding through holes and extend obliquely in opposite directions, and the third elastic arm and the fourth elastic arm are exposed from the other end of the corresponding through holes and extend obliquely in opposite directions.

6. The electrical connector as claimed in claim 2, wherein the through holes are arranged in a plurality of rows and columns on the middle wall, and the terminal pairs are arranged in the through holes in a plurality of rows and columns.

7. The electrical connector as claimed in claim 6, wherein the ground shield member comprises a plurality of first ground shield pieces and second ground shield pieces arranged in rows and columns respectively, and the plurality of first ground shield pieces and second ground shield pieces form a plurality of shielding cavities respectively surrounding each pair of the terminals.

8. The electrical connector as claimed in claim 7, wherein each first ground shield piece comprises a plurality of first mating tabs protruding to the first receiving space and a plurality of second mating tabs protruding to the second receiving space.

9. The electrical connector as claimed in claim 7, wherein the middle wall is provided with a plurality of channels penetrating the middle wall and on both sides of each pair of terminals, and the second ground shield piece is provided with a first contact elastic piece and second contact elastic piece that are exposed in each channel and protrude to both sides respectively.

10. An electrical connector assembly comprising:
a first connector and a second connector;
a circuit board comprising a first side, a second side opposite to the first side; and
an electrical connector mounted on the circuit board, the first connector and the second connector connected with the electrical connector from both sides of the circuit board respectively, the electrical connector comprising:
an insulating housing having a plurality of through holes;
a plurality of pairs of terminals arranged in rows and columns and held in the through holes, each terminal pair comprising a first terminal and a second terminal for transmitting differential signals; and
a ground shield member held in the insulating housing and arranged around each pair of terminals;
wherein each first terminal comprises a first elastic arm and a second elastic arm respectively exposed from both sides of the through hole, each second terminal comprises a third elastic arm and a fourth elastic arm respectively exposed from both sides of the through hole, and the first elastic arm and the third elastic arm are arranged in mirror symmetry with the second elastic arm and the fourth elastic arm with respect to the circuit board.

11. The electrical connector assembly as claimed in claim 10, wherein the ends of the first elastic arm and the third elastic arm are respectively provided with a first mating portion and a second mating portion connected with the first connector, the first mating portion and the second mating portion are both located in the same plane parallel to the circuit board, the ends of the second elastic arm and the fourth elastic arm are respectively provided with a third mating portion and a fourth mating portion connected with the second connector, and the third mating portion and the fourth mating portion are both located in the same plane parallel to the circuit board.

12. The electrical connector assembly as claimed in claim 11, wherein the first connector and the second connector have substantially same structure, each of the first connector and the second connector comprise a plurality of terminal modules stacked up and down, each of the terminal modules comprises an insulating body, a plurality of signal terminals and a grounding member held in the insulating body, and a cable extending in a first direction and electrically connected to the signal terminals and the grounding member, the signal terminals are arranged in pairs and in a row along a second direction perpendicular to the first direction, the grounding member comprises a plurality of grounding pieces provided on both sides of each pair of the signal terminals and a common grounding piece connected with the plurality of the grounding pieces, the signal terminal comprises a first contact portion connected with the cable and a second contact portion connected with the electrical connector, the first contact portion and the second contact portion of the first connector are both located in a plane perpendicular to the first direction, the second contact portions of each pair of signal terminals are correspondingly connected to the first mating portion and the second mating portion of the electrical connector, the first contact portion and the second contact portion of the second connector are both located in another plane perpendicular to the first direction, and the second contact portions of each pair of signal terminals are correspondingly connected to the third mating portion and the fourth mating portion of the electrical connector.

13. The electrical connector assembly as claimed in claim 12, wherein the first contact portion and the second contact portion are both embedded in the insulating body.

14. The electrical connector assembly as claimed in claim 13, wherein the first contact portion has a circular through-hole structure and is mechanically and electrically connected with a corresponding cable.

15. The electrical connector assembly as claimed in claim 13, wherein the two second contact portions arranged in pairs are parallel to each other and extend obliquely in opposite directions from the first contact portion.

16. The electrical connector assembly as claimed in claim 12, wherein the ground shield member of the electrical connector comprises a plurality of first ground shield pieces and second ground shield pieces arranged in rows and columns and surrounding each pair of the terminals, each of the grounding pieces of the first connector and the second connector has a first ground portion extending beyond the signal terminals and extending in a mating direction with the electrical connector, and when the first connector and the second connector are connected with the electrical connector the first ground portion of the first connector and the second connector are respectively connected to both sides of the corresponding second ground shield piece.

17. The electrical connector assembly as claimed in claim 16, wherein a plurality of slots are provided between the insulating bodies on adjacent sides of adjacent terminal modules, and when the first connector and the second connector are connected with the electrical connector one end of the first ground shield piece of the electrical connector extends into the corresponding slot of the first connector and the other end extends into the corresponding slot of the second connector.

18. The electrical connector assembly as claimed in claim 10, wherein the terminal pairs of the electrical connector are arranged in same number of rows and columns and are arranged in a square shape.

19. An electrical connector system comprising:
an organizer comprising a first side a second side opposite to the first side; and
a plurality of electrical connector assemblies each comprising an electrical connector held on the organizer and a first connector and a second connector connected with the electrical connector from both sides of the organizer respectively, the electrical connector comprising:
an insulating housing having a plurality of through holes;
a plurality of terminals pairs arranged in rows and columns held in the through holes, each terminal pair comprising a first terminal and a second terminal for transmitting differential signals; and
a ground shield member held in the insulating housing and arranged around each pair of terminals;
wherein each first terminal comprises a first elastic arm and a second elastic arm respectively exposed from both sides of the through hole, each second terminal comprises a third elastic arm and a fourth elastic arm respectively exposed from both sides of the through hole, and the first elastic arm and the third elastic arm are arranged in mirror symmetry with the second elastic arm and the fourth elastic arm with respect to the organizer.

20. The electrical connector system as claimed in claim 19, wherein the organizer directly forms the insulating housing of the electrical connectors.
